(19) United States
(12) Patent Application Publication
(10) Pub. No.: US 2009/0137174 A1
(43) Pub. Date: May 28, 2009

(54) FLAME-RETARDANT POLYMERIC COMPOSITIONS

(75) Inventors: Don Gary Barber, West Chester, PA (US); Elisabeth S. Papazoglou, Yardley, PA (US)

Correspondence Address: RATNERPRESTIA, P.O. BOX 980, VALLEY FORGE, PA, 19482, US

(73) Assignee: POLYMER PRODUCTS COMPANY, INC., Stockertown, PA (US)

(21) Appl. No.: 12/266,995

(22) Filed: Nov. 7, 2008

Related U.S. Application Data
(63) Continuation of application No. PCT/US2007/068506, filed on May 8, 2007.
(60) Provisional application No. 60/798,527, filed on May 8, 2006.

(51) Int. Cl. B32B 27/04; C08K 3/34; C08K 5/06; C08K 5/3417; C08K 5/51

(52) U.S. Cl. 442/146; 524/450; 524/371; 524/104; 524/136

(57) ABSTRACT

A flame-retarded polymeric composition is provided which contains a) a polyolefin, b) a mixture of a halogenated flame-retardant and zeolite, and optionally c) a synergist. Also provided is a flame and smoke-retarded polymeric composition containing a polyolefin and a mixture of a hydrated metal oxide and zeolite.

### CROSS-REFERENCE TO RELATED APPLICATIONS

This application is a continuation under 35 USC Sections 365(c) and 120 of International Application PCT/US2007/068506, filed 8 May 2007 and published in English on 22 Nov. 2007 as WO 2007/134080, which claims priority from U.S. Provisional Application No. 60/798,527 filed 8 May 2006, each of which is incorporated herein by reference in its entirety.

### FIELD OF THE INVENTION

This invention relates to ignition-resistant thermoplastic polymeric compositions.

More particularly, this invention relates to polymeric compositions that have flame-resistant and smoke-resistant properties by virtue of the presence therein of a material which is capable of functioning as a flame-retardant and smoke-suppressant.

### DISCUSSION OF THE RELATED ART

The inherent flammability of most polymers makes them of restricted use unless their flammability is controlled by incorporation of ingredients that make them ignition-resistant, for example, both flame- and smoke-resistant. Polymers are used to make a whole host of “plastic” articles and, for many applications, regulations mandate that the articles have ignition-resistant properties that pass standard tests, as explained below. Accordingly, polymeric-based compositions from which the articles are formed must have satisfactory ignition-resistant properties.

The present invention relates to polyolefinic-based compositions which have ignition-resistant properties and which can be formed into a variety of articles that are used in many types of applications.

The following publications disclose flame-retarded polymeric compositions, including compositions which comprise a polyolefin: U.S. Pat. Nos. 3,516,959 and 6,780,348; Japanese Patent Nos. 62199654 and 1225646; and Japanese published patent application bearing Publication No. 62-199654. Each of the aforementioned publications discloses various types of polymers in admixture with well known flame-retardants, for example, organo halogenated flame-retardants or a hydrated metal oxide, and also various additives, including, for example, zeolite.

The present invention relates to fire-retarded polyolefin-based compositions that include zeolite and that have characteristics that are unique relative to prior art compositions.

### BRIEF SUMMARY OF THE INVENTION

Pursuant to the present invention, there is provided a flame-retarded polymeric composition comprising: (A) about 50 to about 94 wt. % of a polyolefin; and (B) about 6 to about 50 wt. % of a mixture of a halogenated flame-retardant and zeolite, wherein zeolite comprises about 20 to about 50 wt. % of said mixture; or (C) about 6 to about 50 wt. % of a mixture of a halogenated flame-retardant, zeolite, and a synergist; wherein the zeolite and the synergist comprise about 20 to about 65 wt. % of the mixture and wherein zeolite comprises about 1 to less than 100 wt. % of the amount of the zeolite and synergist; wherein the amounts of said flame-retardant and zeolite in said mixture of (B) or the amounts of said flame-retardant, zeolite, and synergist in said mixture of (C) are such that the composition passes the flame-resistant requirements of NFPA 701 or analogous tests.

Preferred polyolefins for use in the invention are polyethylene and polypropylene.

Examples of synergists for use in the above composition are an antimony-containing compound and a hindered amine stabilizer. The zeolite can be a natural or synthetic zeolite.

Another embodiment of the present invention comprises articles made from the aforementioned composition, for example, flame-retarded polyolefin film used in the construction industry, coated polyolefin membranes, polyolefin fibers, and polyolefin tapes of varying thickness.

Still other embodiments of the present invention include precursor compositions that can be used to formulate the aforementioned composition.

There is provided also by the present invention a flame and smoke-retarded polymeric composition comprising: (A) about 30 to about 60 wt. % of a polyolefin; and (B) about 40 to about 70 wt. % of a mixture of a hydrated metal oxide and zeolite; wherein the zeolite comprises about 1 to about 20 wt. % of the mixture; and wherein the amounts of the metal oxide and zeolite are such that the flame-resistant and smoke-suppressant properties of the composition are satisfactory, as evaluated by the cone calorimeter test, and/or the results of such test indicate that the flame- and smoke-suppressant properties of an article made from the composition should pass the flame and smoke requirements of Steiner tunnel tests.

Examples of metal oxides for use in the aforementioned compositions are hydroxides of aluminum and magnesium.

Another embodiment of the present invention comprises articles made from the aforementioned metal oxide-containing composition. Examples of such articles include extruded polyolefin rigid sheets and wire and cable jacketing made from the polyolefin-based composition.

Various advantages that flow from the provision of the compositions of the present invention are described below.

### DETAILED DESCRIPTION OF CERTAIN EMBODIMENTS OF THE INVENTION

The polymeric composition of the present invention comprises a polyolefin, a flame-retardant, and zeolite which is a well known material.

It is well known to use polyolefins in compositions which are formed into articles that have ignition-resistant properties; such polyolefins are thermoplastic and can be used in the practice of the present invention. Examples of polyolefins are polyethylene, polypropylene, and polybutene; homopolymers or copolymers thereof can be used. It is expected that polyethylene and polypropylene will be used most widely in the compositions of the present invention. Polyethylenes include, for example, low density polyethylene, linear low density polyethylene, high density polyethylene, and metallocene-based polyethylene, including both homopolymers and copolymers. Various of the polypropyplenes that are suitable for use in articles having ignition-resistant properties, as known, can be used in the compositions of the present invention.

Examples of copolymers of polyethylene are the reaction products of ethylene and the following co-monomers: vinyl acetate, methyl acrylate, ethyl acrylate, methacrylic acid, acrylic acid, hexene, butene, octene, and propylene. Copolymers of polypropylene are typically based on using ethylene as the co-monomer. Compounded and reactor based thermoplastic polyolefin (TPO), EPDM and polybutene are other examples. A mixture of two or more polyolefins can be used in the compositions of the present invention.

Zeolite, when used alone or in combination with other conventional flame-retardants (described in detail below), can reduce the flammability of polymers, their smoke generation and their tendency to develop flaming drips during burning. When used in conjunction with other conventional flame-retardants, zeolites can also lessen or eliminate some of the deleterious side effects of the former, as will be described in more detail below.

Zeolites are natural or synthetic microporous crystalline inorganic compounds with three dimensional structures; they contain silicon, aluminum, and oxygen in their framework and loosely held cations, water, and/or other molecules in their pores.

Natural zeolites are abundantly available around the world. They are formed from the interaction of volcanic rocks and ash layers with alkaline ground water. An important feature of all zeolites is that their frameworks are made of 4-connected networks of atoms. In the aluminosilicate zeolite structures, the networks are made of SiO₄ and AlO₄ tetrahedra linked together at the corners. The framework structures contain linked cages, cavities, or channels and these voids constitute a significant portion of the total zeolite volume. The cages, cavities and channels (collectively “pores”) are generally between about 3 and about 10 microns, to allow small molecules or ions to enter. The SiO₄ and AlO₄ type arrangements also impart to the pores a net negative charge which is responsible for holding cations inside the pores and permits the cations to be exchanged readily with other cations. In total, there are known presently 48 varieties of natural zeolites, more than 150 types have been made synthetically.

All natural zeolites are aluminosilicates. U.S. Pat. No. 5,094,775 describes their general formula. Some common examples of natural zeolites that are useful in the composition of the present invention include: clinoptilolite (hydrated sodium, potassium, calcium aluminosilicate); analcime or analcite (hydrated sodium aluminum silicate); chabazite (hydrated calcium aluminum silicate); harmotome (hydrated barium potassium aluminum silicate); heulandite (hydrated sodium calcium aluminum silicate); laumontite (hydrated calcium aluminum silicate); mesolite (hydrated sodium calcium aluminum silicate); natrolite (hydrated sodium aluminum silicate); phillipsite (hydrated potassium sodium calcium aluminum silicate); scolecite (hydrated calcium aluminum silicate); stellerite (hydrated calcium aluminum silicate); stilbite (hydrated sodium calcium aluminum silicate); and thomsonite (hydrated sodium calcium aluminum silicate).

A preferred natural zeolite is clinoptilolite. It is a white to reddish material with tabular monoclinic tectosilicate crystal structure and has a Mohs hardness of about 3.5 to about 4 and a specific gravity of about 2.1 to about 2.2. Commercially available clinoptilolites do not break down even under extreme pressure.

In comparison to natural zeolites, synthetic zeolites are relatively pure materials that can be made by slow crystallization of silica-alumina gels in the presence of alkalis and organic templates, for example, by the sol-gel process. The exact composition and structure of the product formed by this process depend on the composition of the reaction mixture, pH of the medium, operating temperature, reaction time, and the template used. In the sol-gel process, other elements (metals, metal oxides) can be readily incorporated. Furthermore, the ready scaleability of the sol-gel process makes it a preferred route for zeolite synthesis. A description of the manufacturing processes appears in: Subhash Bhatia, Zeolite Catalysis Principles and Application, CRC Press, Inc. Boca Raton, Fla.; and Japanese Patent Application Laid-Open (Kokai) No. Sho 57-28145.

Synthetic zeolites can be made in forms that have structures that do not occur in nature. Their use can be advantageous in that tetrahedral atoms other than silicon and aluminum can be included in the structure, for example, novel microporous structures, such as, microporous aluminophosphates (ALPO family), various metal substituted aluminophosphates (M-APOs, for example, CoAPO-50), silico-aluminophosphates (SAPO family), and other microporous structures.

There are differences between natural and synthetic zeolites. For example, synthetic zeolites and natural zeolites can vary widely in silica (SiO₂) to alumina (Al₂O₃) ratio. While the simplest form of synthetic zeolite, zeolite A, has a silica to alumina ratio of 1:1, most common natural zeolites have a silica to alumina ratio between 2:1 and 5:1. For example, among the natural zeolites, silica to alumina ratios are: of 5:1 in clinoptotilite; 2:1 in chabazite; and 3:1 in natrolite. Another difference is that natural zeolites, which are formed over tens of thousands of years under natural conditions, have more precisely formed cavities that cannot be duplicated by synthetic processes. Still another difference, particularly between zeolite A and natural zeolites, is that the former breaks down under a mildly acidic environment whereas the latter are more resistant to acidic conditions.

The composition of the present invention can comprise a natural zeolite or a synthetic zeolite or a combination of different forms of natural and different grades of synthetic zeolites. In achieving certain flame-retardant performance, the use of one zeolite may be preferable over another or a composition may be optimized for the type of zeolite used. The choice depends upon various desired parameters including cost, color, physical properties and flame-smoke retardancy of the final product. The zeolite, whether natural or synthetic, can be untreated or surface treated (as known in the art) with such materials as higher fatty acids and their salts such as stearic acid, oleic acid, and salts of stearic acid and oleic acid, or salts of higher alkyl-, aryl-, or alkylaryl-sulfonic acids such as of dodecylbenzenesulfonic acid or the like. Furthermore, the zeolite whether natural or synthetic may be calcined and/or ion-exchanged.

As mentioned above, the zeolite functions as a flame-retardant, as a synergist for a flame-retardant, and as a smoke-suppressant in the most demanding applications requiring flame retardancy. With appropriate selection of the amounts of ingredients comprising the polyolefin-based composition, superior ignition-resistant and physical properties can be achieved in an article made from the composition of the present invention.

In one embodiment of the present invention, the flame-retardant comprises a halogenated flame-retardant. They are well known in the art and are compounds that have an inhibitory effect on the ignition of combustible organic materials, including polymers, for example, thermoplastic polyolefins. More particularly, the flame-retardants are halogenated compounds that release hydrogen halide upon undergoing thermal degradation; this occurs also when they are present in a polymeric composition. When exposed to the heat of a flame, the halogenated compound degrades to produce hydrogen halide. The hydrogen halide, in turn, reacts with highly reactive H and OH radicals that are produced by a burning fuel, for example, a burning polyolefin. The reaction between the hydrogen halide and the H and OH radicals produces inactive H₂O molecules and halogen radicals. Since halogen radicals have a much lower energy state than H or OH radicals, the potential for propagating the radical oxidation reaction (that is, the fire) is lowered.

Any halogenated compound that functions as a flame-retardant can be used in the composition of the present invention. Examples of such halogenated compounds include halogenated aryls, for example, halogenated benzenes, biphenyls, phenols, phenol ethers, phenol esters, bisphenols, diphenyloxides, aromatic carboxylic acids or polyacids, anhydrides, amides or imides thereof; halogenated cycloalkanes or polycycloalkanes; halogenated alkanes, including, for example, halogenated oligomers and polymers thereof; halogenated alkylphosphates; and halogenated alkylisocyanurates. As mentioned above, halogenated flame-retardants are well known in the art (see, for example, U.S. Pat. No. 6,500,889).

Preferably, the halogenated compound comprises bromine; they are the most widely used halogenated flame-retardants. Preferred brominated compounds include brominated cycloalkanes and brominated aryls, for example, brominated bisphenols, brominated phenyl ethers, brominated bisphenol carbonate oligomers, brominated bisphenol epoxies, brominated phtalimides, brominated styrenes, and brominated benzenes.

Another class of halogenated compounds are halogenated organo phosphorous flame retardants including halogenated hydrocarbyl phosphate or phosphonate esters. Commercial examples of halogenated organo phosphorous flame retardants include tris(tribromoneopentyl)phosphate sold as FR-370 and FR 372 by Dead Sea Bromine and a proprietary compound from Italmatch Chemicals called PHOSLITE B631C.

There are also chlorinated compounds that are used commercially. Examples of chlorinated flame retardants include: 1,2,3,4,7,8,9,10,13,13,14,14-dodecachloro-1,4,4a,5,6,6a, 7,10,10a,11,12,12a-dodecahydro-1,4,7,10-dimethanodibenzo (a,e) cyclooctene (DECHLORANE PLUS sold by Oxychem) and chlorinated paraffinic waxes such as those sold by Dover Chemical under the Chlorez tradename.

Examples of particularly preferred brominated flame retardants include decabromodiphenyl oxide, decabromodiphenyl ethane, ethylene bis tetrabromopthalimide, 2,2 bis[4-(2,3-dibromopropoxy)-3,5 dibromophenyl]propane, tris tribromo neo pentyl phosphate.

The composition of the present invention can include also a synergist in combination with a halogenated flame-retardant. This is customary in the art, as explained hereafter.

One of the most commonly used synergists is an antimony compound. It is well known than an antimony compound which functions as a synergist when combined with a halogenated flame-retardant inhibits the propagation of fire more effectively than can be accomplished by a halogenated flame-retardant alone. Interestingly, such antimony compounds do not have flame-retardant properties of their own. An explanation of how they function as synergists follows.

It is believed that a heated halogenated flame-retardant itself functions by forming certain halogen species (for example, HX, X=halogen) which interfere in the gas phase with the energized free-radical “fuel” which is generated from the burning polymer.

It is believed also that the antimony compound reacts with HX to form additional chemical species, for example, volatile antimony halides, which interfere more effectively with combustion in the gas phase. The antimony compound can act also as a free-radical scavenger forming antimony halides which inhibit the burning process.

The term “antimony synergist”, when used herein, means an antimony-containing compound that inhibits the propagation of fire more effectively than that effected by a halogenated flame-retardant alone. Examples of antimony synergists that are used widely are antimony trioxide, antimony pentoxide, and sodium antimonate. The most widely used antimony synergist is antimony trioxide. A mixture of two or more antimony synergists can be used in the composition of the present invention.

As mentioned above, antimony trioxide is the most widely used synergist with a halogenated flame-retardant. It is typically used in powder form, for example, in a particle size of about 1 to about 4 microns; both larger and smaller particle sizes can be used, however.

As will be illustrated in examples which are set forth below, there can be formulated, according to the present invention, zeolite-containing compositions which contain or do not contain a synergist and which pass tests that evaluate the flame-resistant properties of the composition. Examples below illustrate also that by virtue of the use of zeolite, the amount of synergist in the synergist-containing composition can be reduced while maintaining or even improving the flame-retardant properties of the composition.

Replacing or reducing the amount of the synergist is important for various reasons.

As mentioned above, the published literature contains information that raises ecological and health concerns associated with the use of antimony compounds, including antimony trioxide.

Another problem associated with the use of antimony oxide as a synergist for halogenated flame-retardants is that it helps promote smoke formation. This is a serious problem because most deaths from fire occur as a result of smoke-inhalation. For the purpose of countering the “smoke problem” caused by the use of antimony synergists, certain zinc salts are added to the polymeric compositions to reduce generation of smoke, but this reduction comes at the cost of adversely affecting the physical properties of the polymeric composition. (For example, zinc borate and other inorganic compounds are employed to replace a portion of the antimony synergist.) Examples below illustrate that, not only can zeolite be used to improve flame-resistance of the polymeric compositions, it can be used also to suppress the formation of smoke.

Another synergist useful in the practice of the present invention is a sterically hindered amine, for example, as described in U.S. Pat. No. 7,109,260 to Kaprinidis, et al. and U.S. Pat. No. 5,096,950 to Galbo, et al. Although not wanting to be bound by a particular theory, it is believed that the sterically hindered amine thermally and chemically stabilizes the polyolefin and protects it from the deleterious effects of heat and oxygen. The stabilizing effect produced by the sterically hindered amine in combination with the gas phase radical-quenching effect produced by the halogenated flame-retardant synergistically reduces the flammability of the polyolefin.

Sterically hindered amines described in the aforementioned Kaprinidis et al. and Galbo et al. patents include those having the formula:

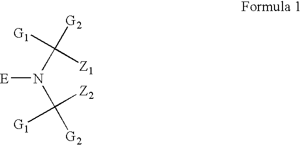

where, G₁ and G₂ are independently alkyl of 1 to 8 carbon atoms or are together pentamethylene; Z₁ and Z₂ are each methyl, or Z₁ and Z₂ together form a linking moiety which may additionally be substituted by an ester, ether, amide, amino, carboxy or urethane group, and E is oxyl, hydroxyl, alkoxy, cycloalkoxy, aralkoxy, aryloxy, —O—CO—OZ₃, —O—Si(Z₄)₃, —O—PO(OZ₅)₂ or —O—CH₂—OZ where Z₃, Z₄, Z₅ and Z are selected from the group consisting of hydrogen, an aliphatic, araliphatic and aromatic moiety; or E is —O-T-(OH)_{b}; T is a straight or branched chain alkylene of 1 to 18 carbon atoms, cycloalkylene of 5 to 18 carbon atoms, cycloalkenylene of 5 to 18 carbon atoms, a straight or branched chain alkylene of 1 to 4 carbon atoms substituted by phenyl or by phenyl substituted by one or two alkyl groups of 1 to 4 carbon atoms; and b is 1, 2 or 3 with the proviso that b cannot exceed the number of carbon atoms in T, and when b is 2 or 3, each hydroxyl group is attached to a different carbon atom of T.

Preferred sterically hindered amines include: 1-cyclohexyloxy-2,2,6,6-tetramethyl-4-octadecylaminopiperidine; 2,4-bis[1-cyclohexyloxy-2,2,6,6-tetramethylpiperidin-4-yl)butylamino]-6-(2-hydroxyethylamino]-s-triazine; bis(1-cyclohexyloxy-2,2,6,6-tetramethylpiperidin-4-yl); adipate; and 2,4-bis[(1-cyclohexyloxy-2,2,6,6-tetramethylpiperidin-4-yl)butylamino]-6-chloro-s-triazine.

A commercially available sterically hindered amine is FLAMESTAB NOR 116 sold by Ciba Specialty Chemicals.

Another embodiment of the present invention comprises a polyolefin-based composition that includes a hydrated metal oxide as a flame-retardant. The use of such oxides as flame-retardants is well known in the art. It is believed that they function by acting as a heat sink and as source of water vapor for “fuel” dilution in the gas phase of the flame.

As the hydrated metal oxide decomposes under the influence of heat, the accompanying reaction is endothermic and removes heat from the burning polymeric composition. This cooling effect reduces the rate of fuel generation by slowing down the decomposition of the polymer; hence flaming is retarded.

Examples of hydrated metal oxides that can be used according to the present invention are aluminum trihydrate, Al(OH)₃ or Al₂O₃.3H₂O (ATH), magnesium hydroxide, alternatively called “hydrated magnesium oxide”, Mg(OH)₂ or MgO₂H₂O. ATH loses about 34.5 percent of its mass as water vapor in the process of decomposition, which starts at about 230° C.

Magnesium hydroxide decomposes at a higher temperature, about 340 degrees C., and loses about 31% of its mass as water vapor. The decompositions of ATH and magnesium hydroxide are endothermic and their enthalpies of decompositions are −280 cal/mole and −328 cal/mole, respectively. Both ATH and hydrated magnesium oxide are often coated with a hydrophobic substance to improve their compatibility with the resin. Stearic acid or metal stearates are commonly used for coating purposes. The composition of the present invention can include one or more of the hydrated metal oxides which are materials that are environmentally acceptable.

A problem associated with the use of a hydrated metal oxide as a flame-retardant is that, to achieve satisfactory flame-retardation, the oxide needs to be used in a relatively high amount, for example, about 40 to about 70 wt. % is typical with ATH or magnesium hydroxide. The unfavorable consequence of the use of such relatively high amounts of the oxides is the reduction of physical properties of the resin and articles made therefrom. As a result, in spite of their favorable ecological profile, the uses of the oxides are restricted to less demanding applications. According to the present invention, zeolite can be used as a co-flame-retardant; this results in the use of lower amounts of the flame-retardant, and in significant smoke reduction.

The prior art describes zeolite as an effective heat stabilizer for polymeric compositions, often in combination with such other stabilizers as: hydrotalcite, dibutyl tin maleate and dolomite which are used for their acid-scavenging ability. As described above, zeolite by itself has the surprising ability to reduce the flame and smoke characteristics of a polyolefin-based composition. Accordingly, the composition of the present invention, in preferred form, is substantially free of the aforementioned stabilizers, that is, it contains in total no more than about 2 wt. % of the stabilizers. It need not contain any of such stabilizers.

The composition of the present invention can include, however, various additives which enhance various properties of the composition. Examples of such additives are antioxidants, process stabilizers, UV absorbers and UV stabilizers, such as hindered amines, pigments and fillers. Their use is known in the art. Typically, they comprise up to about 4 wt. % of the composition and replace a portion of the polyolefin.

Additional embodiments of the present invention include precursor compositions that can be used to prepare the polyolefinic-based composition of the invention and that include therein a halogenated flame-retardant and zeolite and optionally a synergist. Such precursor compositions are in the form of powder blends of ingredients or of masterbatches of ingredients.

One of the precursor compositions comprises a powder blend which is effective in imparting ignition-resistant properties to a composition which comprises a thermoplastic polyolefin when admixed therewith and which comprises a mixture of a halogenated flame-retardant and zeolite, wherein the zeolite comprises about 5 to about 50 wt. % of said mixture.

Another of the precursor compositions comprises a powder blend which is effective in imparting ignition-resistant properties to a composition which comprises a thermoplastic polyolefin when admixed therewith and which comprises a mixture of a halogenated flame-retardant, zeolite, and a synergist, wherein the zeolite and the synergist comprise about 5 to about 50 wt. % of the mixture and wherein zeolite comprises about 5 to less than 100 wt. % of the amount of the zeolite and synergist.

In each of the aforementioned powder blends, the halogenated flame-retardant comprises at least about 50 wt. % of the mixture and can be present in the mixture in an amount up to about 95 wt. %; however, the mixture can include materials that replace a portion of the flame-retardant, for example, additives as mentioned above.

Still another precursor composition comprises a powder blend which is suitable for including in a flame-retardant polyolefin-based composition and which comprises about 10 to about 90 wt. % of a synergist and about 10 to about 90 wt. % of zeolite.

With regard to the precursor compositions that are masterbatches, it is known in the art to form masterbatches that are solid compositions comprising a carrier which has dispersed therein various ingredients and to use such masterbatches to form final compositions or products. Typically used carriers are paraffinic waxes, metal stearates and various polymers.

For the purpose of the present invention, the carrier comprises preferably a polyolefin, most preferably a polyethylene or a polypropylene depending on which polymer comprises the flame-retardant composition. The following are embodiments of the present invention in the form of masterbatches: (A) a masterbatch which is effective in imparting ignition-resistant properties to a polyolefin-based composition when admixed therewith and which comprises about 10 to about 50 wt. % of a carrier having dispersed therein about 50 to about 90 wt. % of a mixture of a halogenated flame-retardant and zeolite, wherein the zeolite comprises about 5 to about 50 wt. % of said mixture; (B) a masterbatch which is effective in imparting ignition-resistant properties to a polyolefin-based composition when admixed therewith and which comprises about 10 to about 50 wt. % of a carrier having dispersed therein about 50 to about 90 wt. % of a mixture of a halogenated flame-retardant zeolite, and a synergist and wherein the zeolite and synergist comprise about 5 to about 50 wt. % of mixture and the zeolite comprises about 5 to less than 100 wt. % of the amount of the zeolite and synergist; (C) a masterbatch which is suitable for including in a flame-retardant polyolefin-based composition and which comprises about 10 to about 50 wt. % of a carrier having dispersed therein about 50 to about 90 wt. % of a mixture of a synergist and zeolite, wherein zeolite comprises about 10 to about 90 wt. % of said mixture; and (D) a masterbatch which is suitable for including in a flame-retardant polyolefin-based composition and which comprises about 10 to about 50 wt. % of a carrier having dispersed therein about 50 to about 90 wt. % of zeolite.

Additional embodiments of the present invention are articles that are made from compositions of the present invention and that have ignition-resistant properties. Examples of articles that are formed from a composition that includes a halogenated flame-retardant are: polyethylene film that is used in the construction industry for temporary barriers and film used by FEMA (Federal Emergency Management Agency) as temporary tarps to protect damaged roofs from the elements and film used in greenhouses and also interwoven, coated interwoven polyethylene membrane used, for example, in the form of tarps and awnings, and also such membranes used in semi-permanent structures, for example, recreational buildings, temporary garages, canopies, construction shelters and the like.

Examples of articles made from a composition of the present invention that includes a metal oxide flame retardant include extruded polyethylene or polypropylene rigid sheets that are used as partitions in public buildings or that are used to construct wet benches employed in electronics manufacture. Other exemplary articles are wire and cable jacketing made from polyethylene or polyethylene copolymers.

Flame retardancy of a material or composition can be measured by several methods, depending on the demands of the end use application. For example, in electrical and electronics applications, the UL-94 test is a common requirement, and the specifier may demand a V-2 or V-O rating.

In textiles, films and fibers, there are used the NFPA 701 test and similar tests that are referred to herein as “analogous tests” and that include: Boston Fire Marshall Test BFD IX-I, California Fire Marshall Fire Code, Canadian CAN/ULC S-109, British Standards BS 7837, BS 5438 and BS 5867, German DIN 4102 BI and ISO 694.

In building applications, Steiner tunnel tests like ASTM E-84, UL 910, NFPA 255, CSA-FT6, or NFPA 262 are often required. These tests measure both the smoke and flame characteristics of the particular article that comprises the composition of the present invention.

Cone Calorimeter tests measure the flame and smoke characteristics of the precursor polymeric composition. Various agencies have their own version of the test. Examples are: ASTM E1354, NFPA 271, ISO 5660 and CAN/ULC S135. These various cone calorimetry tests give similar results and are often used as an indicator of the results one might expect with the Steiner tunnel tests.

Other tests of significance specified by ASTM include the following: ASTM D 2859-76 Methenamine Pill test; ASTM E648-86 Flooring Radiant Panel test; ASTM E-136-82, ASTM E162-83 radiant panel tests; and ASTM D2863—Oxygen Index test.

Other non-ASTM tests include: German MI, M2, M3, DIN 4102 AI, A2, BI-B3; British Crib test; French Epiradiateur tests; and Cone calorimeter tests such as ISO DP 5650 or ASTM E-1354.

Transportation tests include: Motor vehicles FMVSS 302 or JIS D1201-1973; Aviation FAR Part 25, FAR Part 23, Airbus Industrie material specs; and Ships SOLAS 1974, IMO Resolution A.472, A.214, A.516.

For electrical and electronic applications, European tests include: Glow wire tests such as tests DIN VDE 0304, Part 3.7, Part 3.8, Part 3.9, VDE 0340 for films, VDE 0345, VDE 0470 hot mandrel test, VDE 0471 part 1-2, glow wire test specs, VDE 0471, Part 2-2 Needle flame tests, VDE 0472, and part 804 tests for cables and conductors.

Such tests involve exposure of the test specimen of specified dimensions to heat or a flame for a certain period of time, removal of the flame and or heat source, and observation of how the material extinguishes. Parameters such as length of destroyed material, time it takes for material to extinguish flame, any dripping, production, the heat released during combustion, the rate of heat release and density of smoke can be part of the specification and result in pass or fail according to the test. The details of these tests are included in appropriate codebooks of standards, all of which are hereby incorporated by reference. There is no easy correlation among tests, although generally some are regarded more demanding than others. Formulations that pass one test may not necessarily pass another.

### EXAMPLES

The following description includes examples of compositions within the scope of the present invention and comparative compositions.

### Description of Preparation of Test Samples

In the main, the ignition-resistant properties of test samples were evaluated according to NFPA 701. As mentioned above, this test is used widely to evaluate the flame-retardancy of polymeric compositions that are formed into textiles, for example, fibers or into films.

Compositions which were formed into polypropylene films were formulated as follows. The ingredients comprising the compositions were weighed and dry-mixed. They were then fed into a Banbury mixer and mixed under the following processing conditions: (A) flux temperature—350° F.; (B) flux time—1 min, 30 seconds; (C) run time—5 min, (D) ram pressure—35 psi; and (E) rotor speed—100 rpm.

For forming the polypropylene (PP) films, the compositions from the Banbury mixer were fed into a 1-inch film line and processed under the following temperature conditions: a temperature of 390° F. in each of the die and zones 1, 2, 3; and a melt temperature of 375° F.

The resulting films were tested according to NFPA 701.

Compositions which were formed into low-density polyethylene (LDPE) films were formulated as follows. The ingredients were weighed and dry-mixed. They were fed into a Banbury mixer and mixed under the following processing conditions: (A) flux temperature—280° F.; (B) flux time—1 min; (C) run time—5 min; (D) ram pressure—35 psi; and (E) rotor speed—100 rpm.

For forming the LDPE films, the compositions from the Banbury mixer were fed into a 1-inch film line and processed under the following temperature conditions: a temperature of 200° F. in each of the die and zones 1, 2, and 3; and a melt temperature of 220° F. The resulting films were tested according to NFPA 701.

The basic procedures described above were used also for forming linear, low-density polyethylene films, except as noted hereafter. Banbury conditions for the LLDPE were: (A) flux temperature—300° F.; (B) flux time—1 min; (C) run time—5 min; (D) ram pressure—35 psi; and (E) rotor speed—100 rpm. The film-forming conditions were as follows: (A) die—300° F.; (B) zone 1—200° F.; (C) zone 2—250° F.; (D) zone 3—250° F.; and (E) melt—255° F.

For all of the test samples, flame testing was as described in the National Fire Protection Agency NFPA 701-2004 Edition Standard (available from ANSI for example).

Identification of Various Zeolites of Test Samples Natural zeolites used in the compositions were: (A) a naturally occurring form of zeolite called “clinoptilolite”, hereafter “natural zeolite 1”; and (B) clinoptilolite of aforementioned (A) in ground form, hereafter “natural zeolite 2.”

Synthetic zeolites used in the compositions were Type A synthetic zeolites characterized by the following particle sizes, pore sizes, and moisture contents according to manufacturer's specification.

| | Particle Size | | |
|---|---|---|---|
| Grade | Range (microns) | <10 micron % | <20 micron % |
| Synthetic zeolite 1 | 3-6 | Not applicable | Not applicable |
| Synthetic zeolite 2 | 3-6 | >90 | >98 |
| Synthetic zeolite 3 | 2-5 | >90 | >98 |
| Synthetic zeolite 4 | 2-4 | >99 | 100 |

In all of the compositions of the examples, “wt. %” means weight percent based on the total weight of the composition.

Table 1 below describes a composition within the scope of the present invention and four comparative compositions. Each of the compositions comprises a low-density polyethylene homopolymer, decabromodiphenyl oxide flame retardant (DE-83-R, Chemtura Corporation) and either antimony trioxide synergist or zeolite or a mixture thereof. Ignition-resistant properties, as evaluated pursuant to NFPA 701, of the composition are set forth in Table 1. As mentioned above, this test is used frequently to evaluate ignition-resistant properties of polymer compositions in the form of textiles, films and fibers. In addition, Table 1 includes information as to whether smoke was generated by the burning test samples.

TABLE 1
Amount of
Ingredient, wt. %

| | Example No. | | | | |
|---|---|---|---|---|---|
| Ingredients | 1 | 1-A | C-1 | C-1A | C-1B |
| Low-density | 73 | 84 | 73 | 73 | 84 |
| polyethylene | | | | | |
| Decabromo | 20 | 12 | 20 | 20 | 12 |
| diphenyl | | | | | |
| oxide | | | | | |
| Antimony | 4 | — | 7 | — | 4 |
| trioxide | | | | | |
| Zeolite | 3 | 4 | — | 7 | — |

NFPA 701
Test Results

| | | | | | |
|---|---|---|---|---|---|
| Length of | 4.7 | 4.5 | 4.4 | 5.3 | 4.2 |
| burned | | | | | |
| material, | | | | | |
| inches | | | | | |
| Cotton ignites | no | no | no | yes | no |
| Pass | yes | yes | yes | no | yes |
| Evolution of | no | yes | yes | yes | yes |
| smoke | | | | | |

Table 2 below describes a composition within the scope of the present invention and two comparative compositions. The compositions are like those of Table 1, except that the flame-retardant of the compositions is ethylenebistetrabromophthalimide (Saytex BT-93 from Albemarle Corporation). Ignition-resistant properties of the composition are set forth also in Table 2, including whether or not smoke was generated by the burning test samples. This is additional information provided to elucidate the advantages and surprising performance of zeolites. Smoke evolution is not a requirement for NFPA 701.

TABLE 2
Amount of
Ingredients, wt. %
Example No.

| Ingredients | 2 | C-2 | C-2A |
|---|---|---|---|
| Low-density | 84 | 84 | 73 |
| polyethylene | | | |
| Saytex BT-93 | 12 | 12 | 20 |
| Antimony trioxide | — | 4 | 7 |
| Zeolite | 4 | — | — |

NFPA 701
Test Results

| | | | |
|---|---|---|---|
| Length of burned | 4.6 | 4.2 | 4.5 |
| material, inches | | | |
| Cotton ignites | no | no | no |
| Pass | yes | yes | yes |
| Evolution of smoke | no | yes | yes |

The examples in Table 3 below compare the smoke-suppressant capabilities of zeolite to zinc stannate at 8 wt. % loading levels in the cone calorimeter testing method (ASTM E1354—Standard Method for Heat and Visible Smoke Release). At 8 wt. % zeolite (Example No. 3), the average specific extinction area, a measure of smoke evolution, is reduced from 120 to 86 m²/Kg, with equivalent total heat release rate and less peak heat release rate.

TABLE 3
Amounts of
Ingredients, wt. %
Example No.

| Ingredients | 3 | C-3 |
|---|---|---|
| Polypropylene impact | 17.35 | 17.35 |
| copolymer, MFI = 12 | | |
| Polypropylene copolymer, | 17.35 | 17.35 |
| MFI = 0.5 | | |
| Magnesium hydroxide | 57 | 57 |
| Zeolite | 8 | — |
| Zinc stannate | — | 8 |
| Hindered amine light stabilizer | 0.3 | 0.3 |

Cone Calorimeter
Data at 35 kW

| | | |
|---|---|---|
| Peak heat release rate | 133 | 151 |
| (kW/m²) | | |
| Total heat release rate | 69.1 | 64 |
| (kW/m²) | | |
| Average specific extinction | 86 | 120 |
| area (m²/Kg) | | |

Table 4 below shows the effect of partially replacing antimony trioxide with zeolite in a formulation containing 2,2-bis[4-(2,3-dibromopropoxy)-3,5 dibromophenyl]propane (PE-68, Chemtura Corporation). As can be seen from the test data set forth in Table 4, the length of the burned test sample is substantially reduced by the partial substitution of antimony trioxide with zeolite, while the total load level remains constant.

TABLE 4
Amounts of
Ingredients, wt. %
Example No.

| Ingredients | 4 | C-4 |
|---|---|---|
| Polypropylene impact | 86.5 | 86.5 |
| copolymer, MFI = 12 | | |
| PE-68 | 10 | 10 |
| Antimony trioxide | 1.5 | 3.5 |
| Natural zeolite | 2 | — |

NFPA 701
Test Results

| | | |
|---|---|---|
| Length of burned material, | 2.67 | 4.42 |
| inches | | |
| Cotton ignites by flaming drip | No | No |
| pass | Yes | yes |

Table 5 below shows the effect of total or partial substitution of antimony trioxide with zeolite in a polypropylene formulation containing decabromodiphenyl oxide (DE-83R from Chemtura Corporation). In this case, both partial and total substitution of antimony trioxide with zeolite result in significant reduction in length of burned material.

TABLE 5
Amounts of
Ingredients, wt. %
Example No.

| lngredients | 5 | C-5 | 5-A |
|---|---|---|---|
| Polypropylene impact | 73 | 73 | 73 |
| copolymer, MFI = 12 | | | |
| Decabromodiphenyl | 20 | 20 | 20 |
| oxide | | | |
| Antimony trioxide | 0 | 7 | 5 |
| Natural zeolite | 7 | — | 2 |

NFPA 701
Test Results

| | | | |
|---|---|---|---|
| Length of burned | 3.5 | 4.58 | 3.67 |
| material, inches | | | |
| Cotton ignites by | No | No | No |
| flaming drip | | | |
| pass | Yes | Yes | Yes |

Table 6 below shows that the amount of brominated flame-retardant, in this case decabromodiphenyl oxide, can be lowered when zeolite is added to a composition containing linear low density polyethylene (LLDPE).

TABLE 6
Amounts of
Ingredient, wt. %

| | Example No. | | | | | |
|---|---|---|---|---|---|---|
| Ingredients | 6 | C-6 | C-6A | C-6B | C-6C | C-6D |
| Linear low- | 91 | 90 | 90 | 84 | 84 | 88 |
| density | | | | | | |
| polyethylene | | | | | | |
| Decabromo | 6 | 6 | 5 | 12 | 12 | 8 |
| diphenyl | | | | | | |
| oxide | | | | | | |
| Antimony | 0 | 4 | 0 | 4 | 0 | 0 |
| trioxide | | | | | | |
| Natural | 3 | 0 | 5 | 0 | 4 | 4 |
| zeolite-1 | | | | | | |

NFPA 701
Test Results

| | | | | | | |
|---|---|---|---|---|---|---|
| Length of | 4.1 | 4.1 | 4.5 | 3.42 | 4.42 | 4.25 |
| burned | | | | | | |
| material, | | | | | | |
| inches | | | | | | |
| Cotton ignites | No | No | No | No | No | No |
| by flaming | | | | | | |
| drip | | | | | | |
| pass | Yes | Yes | Yes | Yes | Yes | Yes |

The various toxicological and environmental studies of combustion of brominated flame-retardants make it clear that the presence of antimony or other heavy metal compounds exacerbates the decomposition of the retardants to more environmentally harmful chemicals.

In a further set of experiments that are reported in Table 7 below, polypropylene impact copolymer (Equistar) was used as the polymer in the formulations with decabromodiphenyl oxide (Chemtura Corporation DE83R) and with zeolites (synthetic and natural). The test results show that such compositions pass the flame tests in the absence of the use of an antimony compound.

TABLE 7
Amount of
Ingredient, wt. %

| | Example No. | | | | | |
|---|---|---|---|---|---|---|
| Ingredient | 7 | 7-A | 7-B | 7-C | 7-D | C-7 |
| Polypropylene impact | 90 | 90 | 90 | 90 | 90 | 90 |
| copolymer MFI = 12 | | | | | | |
| Decabromodiphenyl | 5 | 7 | 7 | 7 | 7 | 7 |
| oxide | | | | | | |
| Antimony trioxide | | | | | | 3 |
| Synthetic zeolite 1 | 5 | 3 | | | | |
| Synthetic zeolite 4 | | | 3 | | | |
| Synthetic zeolite 3 | | | | 3 | | |
| Natural zeolite 1 | | | | | 3 | |

NFPA 701
Test Results

| | | | | | | |
|---|---|---|---|---|---|---|
| Length of burned | 3.58 | 4.92 | 4.17 | 4.58 | 3.67 | 3.5 |
| material, inches | | | | | | |
| Cotton ignites by | Yes | Yes | Yes | Yes | No | Yes |
| flaming drip | | | | | | |
| pass | Yes | Yes | Yes | Yes | Yes | Yes |

Tables 8 to 10 below show results obtained using linear low-density polyethylene as the polymer in the compositions of the present invention.

TABLE 8
Amounts of Ingredients, wt. %

| | Example No. | | | | |
|---|---|---|---|---|---|
| Ingredients | 8 | 8-A | 8-B | 8-C | C-8 |
| Linear, low density | 88 | 88 | 88 | 88 | 88 |
| polyethylene MFI = 8 | | | | | |
| Decabromodiphenyl | 8 | 8 | 8 | 8 | 8 |
| oxide | | | | | |
| Antimony trioxide | | | | | 4 |
| Synthetic zeolite 1 | | 4 | | | |
| Synthetic zeolite 4 | | | 4 | | |
| Synthetic zeolite 3 | | | | 4 | |
| Natural zeolite 1 | 4 | | | | |

NFPA 701
Test Results

| | | | | | |
|---|---|---|---|---|---|
| Length of burned | 4.82 | 5.0 | 4.59 | 4.95 | 4.96 |
| material, inches | | | | | |
| Cotton ignites by | No | No | No | Yes | Yes |
| flaming drip | | | | | |
| pass | Yes | Yes | Yes | No | No |

The results of Table 8 above show also that drip-suppression is achieved by use of synthetic zeolites 1 and 4 and natural zeolite 1, but not by use of antimony trioxide and synthetic zeolite 3.

The results in Table 9 below show that, in general, the flame-retardant properties of compositions containing zeolite are better than or about equivalent to compositions containing antimony trioxide, depending on the particular zeolite used.

TABLE 9
Amounts of Ingredients, wt. %

| | Example No. | | | | |
|---|---|---|---|---|---|
| Ingredients | 9 | 9-A | 9-B | 9-C | C-9 |
| Linear, low density | 91 | 91 | 91 | 91 | 91 |
| polyethylene MFI = 18 | | | | | |
| Decabromodiphenyl | 6 | 6 | 6 | 6 | 6 |
| oxide | | | | | |
| Antimony trioxide | | | | | 3 |
| Synthetic zeolite 1 | | 3 | | | |
| Synthetic zeolite 4 | | | 3 | | |
| Synthetic zeolite 3 | | | | 3 | |
| Natural zeolite 1 | 3 | | | | |

NFPA 701
Test Results

| | | | | | |
|---|---|---|---|---|---|
| Length of burned | 5.26 | 4.88 | 4.39 | 5.18 | 5.18 |
| material, inches | | | | | |
| Cotton ignites by | No | No | Yes | Yes | No |
| flaming drip | | | | | |
| pass | Yes | Yes | No | No | Yes |

The test results in Table 10 below show, among other things, that the use of zeolite by itself imparts some flame-resistant properties to the polyethylene-based composition (compare examples C-IO and C-IOA). The test results of Table 10 show also that, in these particular formulations, natural zeolite is a more effective drip-suppressant than its synthetic counterparts.

TABLE 10
Amounts of Ingredients, wt. %

| | Example No. | | | | | | | |
|---|---|---|---|---|---|---|---|---|
| Ingredients | 10 | C-10 | C-10A | C-10B | C-10C | C-10D | C-10E | C-10F |
| Linear, low density | 90 | 90 | 90 | 90 | 90 | 90 | 90 | 90 |
| polyethylene | | | | | | | | |
| Decabromodiphenyl | 5 | — | 0 | 10 | 5 | 5 | 5 | 5 |
| oxide | | | | | | | | |
| Antimony trioxide | | | | | 5 | | | |
| Synthetic zeolite 1 | | | | | | 5 | | |
| Synthetic zeolite 4 | | | 10 | | | | 5 | |
| Synthetic zeolite 3 | | | | | | | | 5 |
| Natural zeolite 1 | 5 | | | | | | | |

NFPA 701
Test Results

| | | | | | | | | |
|---|---|---|---|---|---|---|---|---|
| Length of burned | 4.78 | 6.1 | 5.36 | 5.64 | 4.38 | 4.69 | 5.03 | 4.55 |
| material, inches | | | | | | | | |
| Cotton ignites by | No | No | Yes | No | No | Yes | Yes | Yes |
| flaming drip | | | | | | | | |
| pass | Yes | No | No | No | Yes | No | No | No |

The data in Table 11 below demonstrates that the use of natural zeolite is superior to that of zinc borate in achieving UL-94 VO ratings in a polypropylene formulation containing 2,2-bis[4-(2,3-dibromopropoxy)-3,5 dibromophenyl]propane. The use of zinc borate, commonly used to reduce the use of antimony oxide and improve or maintain flame-resistance results in flaming drips that diminish the flammability rating to V-2. On the contrary, use of zeolite successfully replaces part of the antimony oxide while retaining a V-O rating.

TABLE 11
Amounts of Ingredients, wt. %

| | Example No. | | | | | | |
|---|---|---|---|---|---|---|---|
| Ingredients | 11 | 11-A | 11-B | 11-C | C-11 | C-11A | C-11B |
| Polypropylene | 82.5 | 82.5 | 82.5 | 82.5 | 82.5 | 82.5 | 82.5 |
| impact | | | | | | | |
| copolymer, | | | | | | | |
| MFI = 12 | | | | | | | |
| PE-68 | 10 | 10 | 10 | 10 | 10 | 10 | 10 |
| Antimony | 3.5 | 3.5 | 3.5 | 3.5 | 3.5 | 4 | 4.5 |
| trioxide | | | | | | | |
| Blue color | 2.5 | 2.5 | 2.5 | 2.5 | 2.5 | 2.5 | 2.5 |
| masterbatch | | | | | | | |
| Zinc borate | — | — | — | — | 1.5 | 1.0 | 0.5 |
| Natural zeolite 2 | 1.5 | | | | | | |
| Natural zeolite 3 | | 1.5 | | | | | |
| Natural zeolite 2 | | | 1.5 | | | | |
| Natural zeolite 1 | | | | 1.5 | | | |

UL-94
Test Results

| | | | | | | | |
|---|---|---|---|---|---|---|---|
| 1/16″ | V-0 | V-0 | V-0 | V-0 | V-2 | V-2 | V-2 |

Table 12 below includes test data that demonstrates that zeolite can maintain efficacy of alkoxy hindered amine/brominated flame-retardant formulations in passing NFPA 701, while reducing the amount of the hindered amine synergist (NOR 116) that is more costly then zeolite. More importantly, as the test results for Example No. C-12 B demonstrate, a formulation containing 5% brominated additive and 2% NOR fails the test, whereas a formulation containing zeolite (No. 12-B) passes the test.

TABLE 12
Amounts of Ingredients, wt. %

| | Example No. | | | | | |
|---|---|---|---|---|---|---|
| Ingredients | 12 | 12-A | 12-B | C-12 | C-12A | C-12B |
| Polypropylene | 86 | 86 | 93 | 86 | 86 | 93 |
| impact | | | | | | |
| copolymer, | | | | | | |
| MFI = 12 | | | | | | |
| Brominated | 10 | | | 10 | | |
| bisphenol A | | | | | | |
| Tris (tribromo | | 10 | 5 | | 10 | 5 |
| neopentyl) | | | | | | |
| phosphate (FR- | | | | | | |
| 370 from | | | | | | |
| Ameribrom) | | | | | | |
| Natural zeolite 1 | 2 | 2 | 2 | | | |
| NOR 116 | 2 | 2 | | 4 | 4 | 2 |
| NFPA 701 | | | | | | |
| Test Results | | | | | | |
| Length of | 3.5 | 3.5 | 4.58 | 4.25 | 4.42 | 5 |
| burned | | | | | | |
| material, | | | | | | |
| inches | | | | | | |
| Cotton ignites | No | No | No | No | No | Yes |
| by flaming drip | | | | | | |
| pass | Yes | Yes | Yes | Yes | Yes | No |

What is claimed is:

1. A flame-retarded polymeric composition comprising:
(A) about 50 to about 94 wt. % of at least one polyolefin; and either
(B) about 6 to about 50 wt. % of a mixture of at least one halogenated flame-retardant and at least one zeolite, wherein zeolite comprises about 20 to about 50 wt. % of said mixture; or
(C) about 6 to about 50 wt. % of a mixture of at least one halogenated flame-retardant, at least one zeolite, and at least one synergist; wherein zeolite and synergist comprise about 20 to about 65 wt. % of the mixture and wherein zeolite comprises about 1 to less than 100 wt. % of the total amount of zeolite and synergist;
wherein the amounts of flame-retardant and zeolite in said mixture of (B) or the amounts of flame-retardant, zeolite, and synergist in said mixture of (C) are such that the composition passes the flame-resistant requirements of NFPA 701 or analogous tests.

2. A composition according to claim 1, including about 70 to about 94 wt. % of polyolefin and about 6 to about 30 wt. % of the mixture of said (B) or of said (C).

3. A composition according to claim 1, including about 80 to about 94 wt. % of the polyolefin and about 6 to about 20 wt. % of the mixture of said (B) or of said (C).

4. A composition according to claim 1, wherein said polyolefin is a homopolymer of ethylene or of propylene or a copolymer of ethylene or of propylene.

5. A composition according to claim 1, including said mixture of (B).

6. A composition according to claim 1, including said mixture of (C).

7. A composition according to claim 6, wherein said synergist includes at least one antimony synergist.

8. A composition according to claim 6, wherein said synergist includes at least one hindered amine stabilizer.

9. A composition according to claim 1 wherein said zeolite includes at least one natural zeolite.

10. A composition according to claim 1 wherein said zeolite includes at least one synthetic zeolite.

11. A composition according to claim 1 wherein said zeolite includes zeolite A.

12. A composition according to claim 1 wherein said zeolite includes clinoptilolite.

13. A composition according to claim 1 wherein the halogenated flame-retardant is selected from the group consisting of decabromodiphenyl oxide, decabromodiphenyl ethane, ethylene bis-tetrabromopthalimide, 2,2 bis-[4-(2,3-dibromopropoxy)-3,5 dibromophenyl]propane, and tris tribromo neopentyl phosphate.

14. An article which is formed from the composition of claim 1 and which is selected from the group consisting of: (A) a film that is effective for use as a temporary barrier in the construction industry; (B) a film that is effective for use as a temporary tarp to protect damaged roofs from the elements; (C) a film that is effective for use in greenhouses; (D) an interwoven, coated membrane in the form of a tarp or awning; and (E) an interwoven, coated membrane effective for use in semi-permanent structures.

15. A powder blend which is effective in imparting ignition-resistant properties to a composition which comprises a thermoplastic polyolefin when admixed therewith and which comprises a mixture of at least one halogenated flame-retardant and at least one zeolite, wherein zeolite comprises about 5 to about 50 wt. % of said mixture.

16. A powder blend which is effective in imparting ignition-resistant properties to a composition which comprises a thermoplastic polyolefin when admixed therewith, said powder blend comprising a mixture of at least one halogenated flame-retardant, at least one zeolite, and at least one synergist, wherein zeolite and synergist comprise about 5 to about 50 wt. % of the mixture and wherein zeolite comprises about 5 to less than 100 wt. % of the total amount of zeolite and synergist.

17. A powder blend which is suitable for including in a flame-retardant polyolefin-based composition and which comprises about 10 to about 90 wt. % of at least one synergist and about 10 to about 90 wt. % of at least one zeolite.

18. A masterbatch which is effective in imparting ignition-resistant properties to a polyolefin-based composition when admixed therewith and which comprises about 10 to about 50 wt. % of at least one carrier having dispersed therein about 50 to about 90 wt. % of a mixture of at least one halogenated flame-retardant and at least one zeolite, wherein zeolite comprises about 5 to about 50 wt. % of said mixture.

19. A masterbatch which is effective in imparting ignition-resistant properties to a polyolefin-based composition when admixed therewith and which comprises about 10 to about 50 wt. % of at least one carrier having dispersed therein about 50 to about 90 wt. % of a mixture of at least one halogenated flame-retardant, zeolite and at least one synergist and wherein zeolite and synergist comprise about 5 to about 50 wt. % of said mixture and zeolite comprises about 5 to less than 100 wt. % of the total amount of zeolite and synergist.

20. A masterbatch which is suitable for including in a flame-retardant polyolefin-based composition and which comprises about 10 to about 50 wt. % of at least one carrier having dispersed therein about 50 to about 90 wt. % of a mixture of at least one synergist and at least one zeolite, wherein zeolite comprises about 10 to about 90 wt. % of said mixture.

21. A masterbatch which is suitable for including in a flame-retardant polyolefin-based composition and which comprises about 10 to about 50 wt. % of at least one carrier having dispersed therein about 50 to about 90 wt. % of at least one zeolite.

22. A flame and smoke-retarded polymeric composition comprising: (A) about 30 to about 60 wt. % of at least one polyolefin; and (B) about 40 to about 70 wt. % of a mixture of at least one hydrated metal oxide and at least one zeolite; wherein zeolite comprises about 1 to about 20 wt. % of the mixture; and wherein the amounts of hydrated metal oxide and zeolite are such that the flame-resistant and smoke-suppressant properties of the polymeric composition are satisfactory, as evaluated by the cone calorimeter test, and/or the results of such test indicate that the flame- and smoke-suppressant properties of an article made from the polymeric composition should pass the flame and smoke requirements of Steiner tunnel tests.

23. A composition according to claim 22 including about 35 to about 50 wt. % of polyolefin and about 50 to about 65 wt. % of the mixture of hydrated metal oxide and zeolite, and wherein zeolite comprises about 2 to about 15 wt. % of the mixture.

24. A composition according to claim 22 wherein the hydrated metal oxide is selected from the group consisting of aluminum trihydrate and magnesium hydroxide.

25. A composition according to claim 22 wherein the polyolefin is a homopolymer of ethylene or of propylene or a copolymer of ethylene or of propylene.

26. A composition according to claim 22 wherein said at least one zeolite includes a natural zeolite.

27. A composition according to claim 22 wherein said at least one zeolite includes a synthetic zeolite.

28. A composition according to claim 27 wherein the natural zeolite is clinoptilolite.

29. A composition according to claim 28 wherein the synthetic zeolite is zeolite A.

30. An article which is formed from the composition of claim 22 and which is selected from the group consisting of a rigid sheet in the form of a building partition, a rigid sheet in the form of a wet bench, and wire or cable jacketing.
